(19) United States
(12) Patent Application Publication
(10) Pub. No.: US 2026/0127519 A1
(43) Pub. Date: May 7, 2026

(54) REPEATING CORRECTION SYSTEM

(71) Applicant: SAP SE, Walldorf (DE)

(72) Inventor: Oliver Grob, Illingen (DE)

(21) Appl. No.: 18/936,463

(22) Filed: Nov. 4, 2024

(51) Int. Cl. G06Q 10/0631; G06Q 20/20

(52) U.S. Cl. CPC G06Q 10/06312; G06Q 20/20

(57) ABSTRACT

Systems, methods, and articles of manufacture, including computer program products, are disclosed that provide receiving one or more records from a point-of-service transaction device; storing the received one or more records in a transaction store further including a plurality of records; retrieving at least a first record; checking the first record for a first error in the first record; identifying, for the first error in the first record, a first correction; applying the first correction to the first record; identifying in the plurality records one or more second records with the first error; applying the first correction to the identified one or more second records; and passing the first record and the one or more second records as corrected records to an enterprise resource planning system.

### BACKGROUND

The phrase Enterprise Resource Planning” or “ERP” system refers to a system that integrates processes for an enterprise, such as a business or other type of organization. The ERP system enables the enterprise to manage enterprise functions, such as human resources, purchasing, supply chain management, travel, inventory management, financial control and/or reporting, customer relationship management, and the like. The ERP system may include a database, analytics, reporting, security, and/or other functions.

For example, the database may be configured to store an organized collection of data for the enterprise. To illustrate further, data may be stored in a relational database according to a schema defining one or more relations, each of which being a set of tuples sharing one or more common attributes. The tuples of a relation may occupy the rows of a database table while the columns of the database table may store the values of the common attributes shared by the tuples. Moreover, one or more attributes may serve as keys that establish and identify relationships between the relations occupying different database tables. The database may support a variety of database operations for accessing the data stored in the database. For instance, the database may support transactional processing (e.g., on-line transactional processing (OLTP)) that modifies the data stored in the database. Alternatively, and/or additionally, the database may support analytical processing (e.g., on-line analytical processing (OLAP)) that evaluates the data stored in the database.

### SUMMARY

Systems, methods, and articles of manufacture, including computer program products, are disclosed that provide receiving one or more records from a point-of-service transaction device; storing the received one or more records in a transaction store further including a plurality of records; retrieving at least a first record; checking the first record for a first error in the first record; identifying, for the first error in the first record, a first correction; applying the first correction to the first record; identifying in the plurality records one or more second records with the first error; applying the first correction to the identified one or more second records; and passing the first record and the one or more transaction records as corrected records to an enterprise resource planning system.

In some variations, one or more features disclosed herein including one or more of the following features may be implemented as well. The one or more records are received by a correction system coupled to the enterprise resource planning system. The transaction store is located at the correction system, and wherein the transaction store stores the plurality of records that have not been corrected by the correction system. The correction system retrieves the first record from the transaction store. The correction system performs one or more checks on the first record. The one or more checks include a unit of measure check and/or an article identifier check. The one or more checks further include generating a user interface including the first error to enable confirmation of the first error. The one or more checks further include detecting by a machine learning model the first error. The machine learning model may include a convolutional neural network trained using records with errors and records without errors. The first correction is identified using a confirmation received from a user interface and/or a machine learning model.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable storage medium or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system diagram for a correction, such as audit, system, in accordance with some implementations;

FIG. 2 depicts an example of a point of sale (POS) transaction record including an error, in accordance with some implementations;

FIGS. 3A, 3B, and 3C depict an initial error and initial correction and application of the correction to other POS transaction records that have the same error, in accordance with some implementations;

FIG. 4 depicts an example of an audit process for POS transaction, in accordance with some implementations;

FIG. 5A depicts a block diagram illustrating an example of a computing system, in accordance with some implementations; and

FIG. 5B depicts a block diagram illustrating another example of a computing system using virtual machines for cloud implementations, in accordance with some implementations.

When practical, similar reference numbers denote similar structures, features, or elements.

### DETAILED DESCRIPTION

When transferring point of service (POS) transactions from a POS device, such as a POS register, a POS laptop, or other processor-based POS device, to a system, such as an enterprise resource planning (ERP) system, there may be one or more errors that may occur for a variety or reasons, such as data entry errors, coding errors, human error, software errors, and so forth. In some embodiments, there may be provided a correction system, such as an audit system, to check the transactions provided by one or more POS devices to the ERP system. For example, the audit system may be used to check for (e.g., detect) errors in the POS transactions and, in some instances, before the transactions are provided to the ERP system. Alternatively, or additionally, the audit system may correct (or at least flag) the errors in the POS transactions.

For example, the ERP may perform, based on the POS transaction data, a variety of tasks or functions including, for example, inventory management, analytics, financial management and accounting functions, material documents generation (e.g., ordering replacement items for the location associated with the POS to replenish the sold items); billing documents generation (e.g., payment to vendors); POS transaction data aggregation (e.g., sales totals, etc.); track payments; estimate future demand, and/or other tasks or functions.

However, if there is a high quantity (e.g., more than a threshold amount) of POS transactions with an error, the errored POS transactions may cause errors in the ERP system, and the errored POS transactions may need to be audited separately, which creates backlogs, wasted resources (including wasted processor and memory resources as well as possible semi-manual audits), and/or the like. To illustrate the extent of the problem, a large retailer can have hundreds of thousands of daily POS transactions with an error rate of more than 1%, for example.

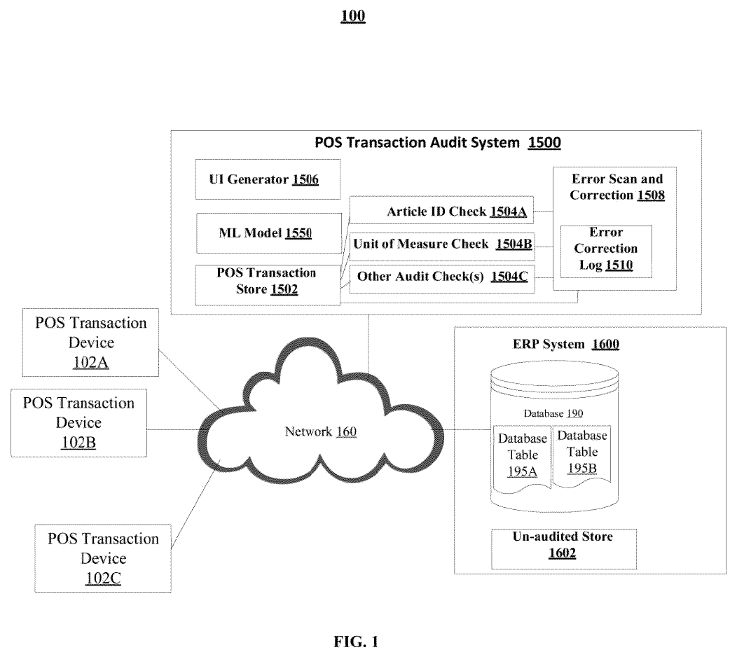

FIG. 1 depicts an example of a system 100 including a plurality of POS transaction devices 102A-C, an audit system 1500, and an ERP system 1600, all of which may be coupled via a network 160. The network 160 may be a wired network and/or wireless network including, for example, a public land mobile network (PLMN), a local area network (LAN), a virtual local area network (VLAN), a wide area network (WAN), the Internet, and/or the like.

The POS transaction devices 102A-D may comprise a processor-based system including memory and a network interface. The POS transaction devices may comprise or be comprised in a mobile device, a wearable apparatus, a personal computer, a workstation, a tablet computer, an Internet-of-Things (IoT) appliance, and/or the like. When a transaction occurs at a POS transaction device (e.g., POS register or terminal such as the POS transaction device 102A), a user may for example scan an item as part of a purchase of the item. When the item is purchased, the POS transaction device may then generate a POS transaction record listing at least the item as well as other data associated with the item.

In some embodiments, the POS transaction records may be sent from a POS transaction device, such as POS transaction device 102A, to a POS transaction store 1502 (e.g., a cache, a database, an object store, etc.) at an audit system 1500 (labeled “POS Transaction Audit System) while waiting for the audit system 1500 to perform one or more audit checks on the POS transaction records.

Alternatively, or additionally, the POS transaction records may be sent from the POS transaction devices 102A-C to the ERP system 1600, where the POS transaction records are held in an un-audited store 1602 (e.g., a database, an object store, etc.) while waiting for the audit system 1500 to perform one or more audit checks on the POS transactions.

The ERP system 1600 may include for example analytical tools including query tools, ERP functions, and one or more databases, such as a database 190. Moreover, at least a portion (if not all) of the POS transaction records may be stored at the database 190 in one or more database tables 195A-B. Alternatively, or additionally, at least a portion (if not all) of the POS transaction data may be stored in an object store. For example, after the POS transaction records are audited (and/or corrected) by the audit system 1500, the POS transaction records may be stored at the database 190 (or as noted an object store) to enable use by the ERP system 1600.

The one or more databases such as the database 190 may comprise one or more relational database technologies including, for example, an in-memory database, a column-based database, a row-based database, a hybrid database (e.g., combination of column and row based), and/or the like. Alternatively, or additionally, the ERP system may include or be coupled to an object store, such as a cloud object store.

In the case of that the database 190 comprises an in-memory relational database system, the in-memory relational database may utilize main memory (“in-memory”) for the primary storage of database tables. For example, the in-memory relational database may be implemented as a column-oriented database (or a columnar database) that stores data from database tables by columns instead of by rows. In the case of the in-memory column-oriented relational database for example, each tuple of a relation may correspond to a record occupying one row of a database table while the columns of the database table may store the values of the common attributes shared by multiple tuples, such that the values occupying each column of the database table (which may span multiple rows (or records) of the database table) may be stored sequentially in one or more data pages, with each data page storing at least a portion of a column. The in-memory column-oriented relational database may support efficient data compression and partitioning for massively parallel processing. Because the in-memory database is directly accessible by the central processing unit (CPU) of the computing engine, transactions accessing the in-memory database may be executed to provide near-instantaneous results. Alternatively, or additionally, at least a portion (if not all) of the POS transaction data may be stored in an object store.

Although the some of the examples refer to the un-audited POS transaction records being stored at the POS transaction store 1502 and/or the un-audited store 1602, the un-audited POS transaction records may be stored in other locations as well (e.g., object store, database, data lake, etc.) while waiting for processing (e.g., auditing, etc.) by the audit system 1500.

Although FIG. 1 depicts a certain quantity of POS transaction devices, audit system, and ERP system, other quantities and/or configurations of the POS transaction devices, audit system, and ERP system may be implemented as well.

In some embodiments, the audit system 1500 may retrieve one or more of the POS transaction records stored in the POS transaction store 1502. The audit system 1500 may then use the retrieved POS transaction records to perform one or more audit checks, such as an article ID check 1504A (which checks for errors in the article ID of the POS transaction record), a unit of measure (UOM) check 1504B (which checks for errors in the unit of measure of the POS transaction record), and/or other audit checks 1504C. Other audit checks 1504C of the POS transaction may be performed as well. Examples of the other audit checks include duplicate checks (which searches for transactions which have been transmitted several times); gap checks (e.g., gaps or missing transactions); balance checks (e.g., determines a sum of all items in the transactions and compares to the payment).

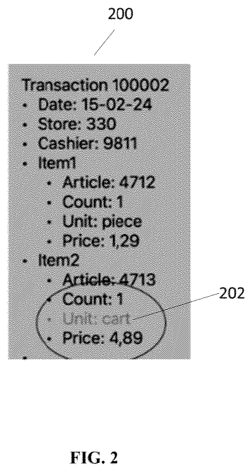

FIG. 2 depicts an example of a POS transaction record 200 generated by for example a POS transaction device, such as the POS transaction device 102A. For example, the POS transaction record 200 may include a Transaction Record Identifier (ID), which in this example is “100002” (which is an identifier for the transaction). Moreover, the POS transaction record may include one or more of the following: a date of the transaction (e.g., 15-02-24”); a store identifier (e.g., Store: 330); a cashier identifier (e.g., Cashier: 9811), and/or other information associated with the transaction.

Furthermore, the POS transaction record 200 may include one or more item descriptions (e.g., “ITEM1”). The item description refers to the item that is the subject of the transaction and thus being sold via the POS transaction device. The item description may further include one or more of the following: an article ID (e.g., 4712 which uniquely identifies the item and may be mapped to a bar code or a UPC code of the item); a count (e.g., a quantity of items being sold); a unit that refers to the units of measure (which in this example, is “1” item; but may be in other forms, such as dozen, cartoon, box, etc.); and item price (e.g., $1.29). In the example of FIG. 2, the POS transaction record 200 includes a second item, “Item2.”

In the example of FIG. 2, the POS transaction record 200 includes an error 202 in the unit. Specifically, the unit “cart” (e.g., carton) is flagged as a unit of measure error (e.g., by the audit system). The mistake unit of measure error of “cart” at error 202 may be detected in a variety of ways. For example, the unit of measure check 1504B and/or the ML model 1550 may detect an error, which in this example is a unit of measure error of “cart” (e.g., error 202). To illustrate further, the unit of measure check 1504B and/or the ML model 1550 may detect that given the price of 4.89 the unit of measure is incorrect. Likewise, the unit of measure check 1504B and/or the ML model 1550 may detect that the item is not sold by the UOM “cart”. Alternatively, or additionally, the UI generator 1506 may present a POS transaction records for audit on a UI presented to a user such as an auditor, where a selection can be used to indicate or flag the error.

Additional examples of POS transaction errors include the following. The POS transaction record may include an incorrect (e.g., errored, wrong, mistaken, etc.) article ID which identifies the item or article that is sold via the POS transaction. Alternatively, or additionally, the POS transaction record may include an error in the unit of measure. For example, the unit of measure may indicate a quantity of the items in the transaction (e.g., a single item, a dozen items, a box of 12, a case of 24, etc.). In the example of FIG. 2, the unit of measure is detected as an error when an audit check is performed on the unit of measure. Alternatively, or additionally, the POS transaction record may include an incorrect storeID, incorrect date, invalid address, invalid telephone number, invalid loyalty number, and the like.

Some of the POS transaction record errors may be caused by for example a mistake at the POS device where the transaction is made. For example, a scanning error of the product or the system lacking correct data mapping the bar code to the unit of measure for example. Nonetheless, the audit system 1500 may be used to detects errors and/or correct the error in a POS transaction record.

In some embodiments, the POS transaction records may be processed by a ML model 1550. The ML model 1550 may detect (and/or identify) candidate POS transaction records that might have an error, such as article ID, unit of measure, and/or other errors. Alternatively, or additionally, one or more POS transaction records (which may be un-audited or candidate POS transaction records with possible errors) may be presented as one or more views on a user interface (e.g., the UI generator 1506 generates a UI including one or more of the candidate, errored POS transaction records). At the UI, a user selection can be used to confirm whether the detected or possible error is truly an error (or not an error). Once confirmed, the error may be corrected with the correction, and the corrected POS transaction record may be passed as an audited POS transaction record to the ERP system for storage and/or processing. In some instances, the corrected POS transaction record may undergo additional audit checks by the audit system 1500 before passing to the ERP system.

Alternatively, or additionally, the confirmation at the UI may be used to further train the ML model 1550. For example, the ML model 1550 may comprise a convolutional neural network (CNN), a Recurrent Neural Network (RNN), a LSTM (long short-term memory), and/or a combination of the three. And, the ML model 1550 may be trained using among other things reference data (e.g., POS transactions with errors, POS transaction without errors, as well as confirmed POS transaction records with or without errors). Alternatively, or additionally, machine learning model 1550 may learn to track corrections to the transactions and detect a pattern. In response to a pattern in the corrections, the ML model may propose (or implement) automatic corrections. In some embodiments, the transaction records are stored as images in which case the ML model may comprise the CNN. However, if the transaction records are stored as data records (e.g., text, etc.), the ML mode may comprise the LSTM.

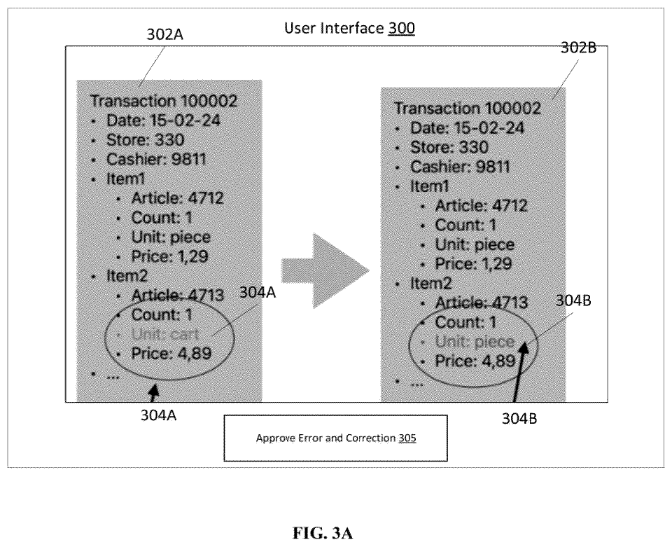

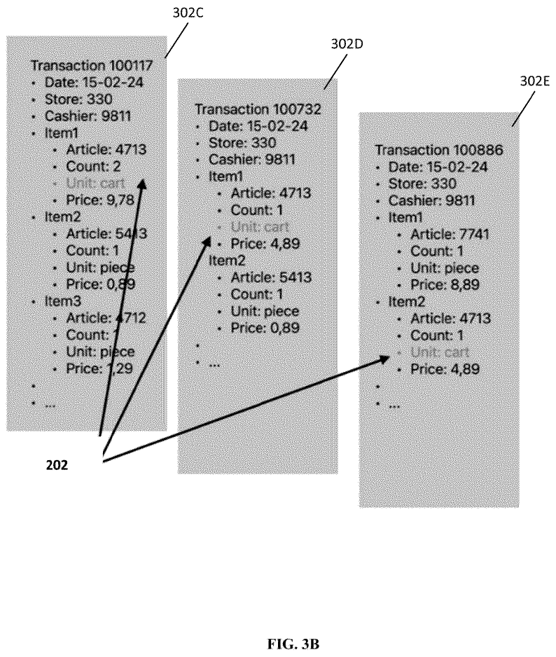

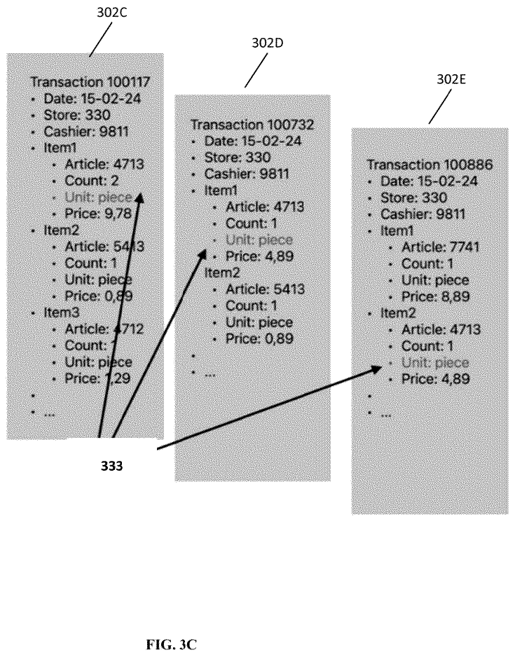

FIG. 3A depicts an example of a user interface 300 including a view of a first POS transaction record 302A that includes a detected error, such as the unit of measure “cart” 304A. The user interface 300 further includes a view of a second POS transaction record 302B that includes a correction, such as the unit of measure “piece” 304B. When the audit system 1500 receives an indication that Approve Error and Correction 305 has been selected at the user interface 300, the error and correction is “confirmed” and may thus be committed so the POS transaction record 302 may be considered “audited” and ready to be passed for use at the ERP system 1600.

In some embodiments, when an error is initially detected in a given POS transaction record, this initial error and corresponding correction is stored and then propagated to other POS transaction records. For example, when the error is detected at FIG. 2 as “cart” and a resolution to correct the error is “piece”, this initial error and correction may be logged or stored in an error and correction log 1510. In some implementations, after the error and correction is logged, the error scan and correction 1508 may scan the POS transaction record (which was initially in error a second time) to confirm the POS transaction record is correct. If correct, the POS transaction is indicated as being “correct” or “audited,” in which case the audited POS transaction may be passed form the audit system 1500 to the ERP system 1600 to allow ERP system processing.

After a successful correction of a POS transaction record, the system 100 (and in particular, the error scan and correction 1508) may search through the POS transaction store 1502 for POS transaction records having the same error as detected by the audit system 1500. Referring to the previous example, the unit of measure check 1504 may detect the error of “cart” (e.g., error 202) and identify a correction as “piece”. In this example, the error scan and correction 1508 may scan or search through the POS transaction store 1502 for other POS transaction records that contain the same “cart”(e.g., error 202).

FIG. 3B depicts an example results from this scan. Referring to FIG. 3B, POS transaction records 302C-E each include the unit of measure error of “cart”. For any records found with the same cart error, the error scan and correction 1508 may automatically apply the correction of “piece” to those POS transaction records. FIG. 3C depicts the correction of “piece” 333 applied to the POS transaction records 302C-E. In some embodiments, the POS transaction records 302C-E are presented in a UI to enable a user, such as an auditor, to confirm the error and/or correction as noted with respect to FIG. 3A.

In some embodiments, the error scan and correction 1508 may use the ML model 1550 to detect the error, such as the “cart” (e.g., error 202), in the POS transaction records stored at the POS transaction store 1502 and identify which records have the error. Alternatively, or additionally, the ML model 1550 (or logic associated with the ML model 1550) may implement the correction, such as change “cart” to “piece”, in the identified POS transaction records, such as POS transaction records 302C-E. In some implementations, the corrected POS transaction records are flagged (e.g., identified) as correct or audited, so the audited POS transaction records can be passed and/or processed by the ERP system 1600. The similar transactions may be similar in the sense that the similar transaction include a similar mistake or error. If for example there is an incorrect UOM (unit of measure) for product 4711 in a transaction, then the system would search all transactions for the same combination of for example product id and unit of measure.

In some embodiments, the POS transaction records, such as POS transaction records 302C-E at FIG. 3B, identified or detected by the audit system 1500 as having an error may be presented as a view on a UI. For example, the UI generator 1506 may generate a UI view including the POS transaction records identified as having an error. Alternatively, or additionally, the UI view may include the correction (e.g., change to “piece”), such that a user selection confirms (see, e.g., FIG. 3A at Approve Error and Correction 305) the accuracy of the detected error and correction. For example, a user, such as an auditor, may be presented with the detected error(s) and correction(s) being applied to the POS transaction record(s).

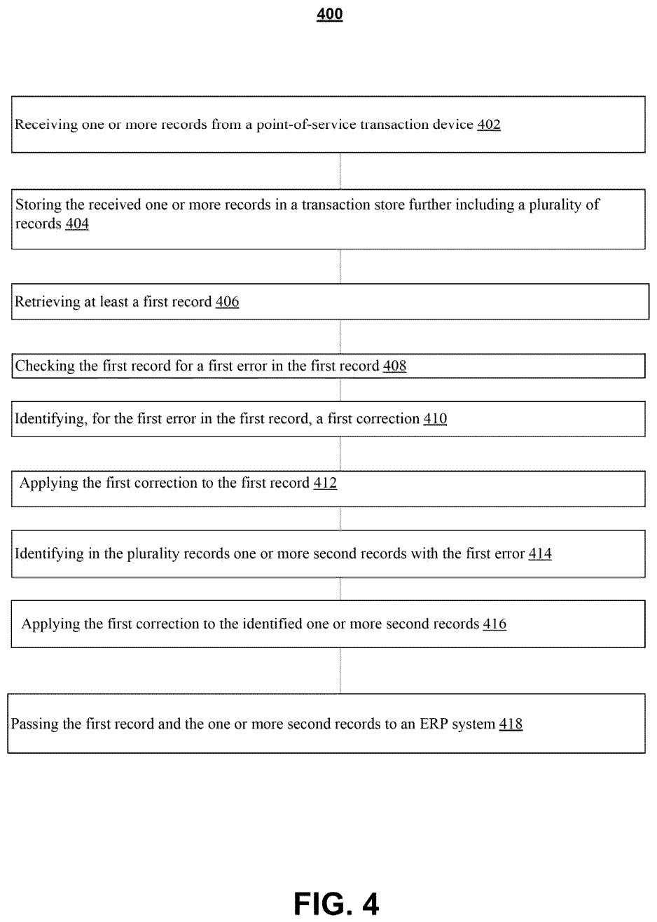

FIG. 4 depicts a flowchart illustrating an example of a process 400 for auditing POS transaction records, in accordance with some implementations. The process 400 may be used to provide a computer-implemented method, for example. The process 400 may be embodied using at least one non-transitory computer-readable medium, for example.

At 402, the process 400 may include receiving one or more records, such as transaction records, from a point-of-service transaction device, in accordance with some embodiments. Referring to FIGS. 1 and 2 for example, one or more transaction records, such as POS transaction record 200, may be generated by for example a POS transaction device. When this is the case, the POS transaction device, such as POS transaction device 102A, may send the POS transaction record. The POS transaction record may be sent to (and thus received by) the audit system 1500 (e.g., POS transaction store 1502), ERP system 1600 (e.g., un-audited store 1602), and/or to other locations.

At 404, the process 400 may include storing the received one or more records in a transaction store further including a plurality of records, in accordance with some embodiments. Referring to FIGS. 1 and 2 for example, the received POS transaction records may be stored at the audit system 1500 at for example the POS transaction store 1502. Alternatively, or additionally, the received POS transaction records may be stored at the ERP system 1600 and, in particular, at the un-audited store 1602. Although the previous examples refer to storing the received POS transaction records in the POS transaction store 1502 and/or the un-audited store 1602, the received POS transaction records may be stored at other locations as well (e.g., a cloud-based object store, data lake, etc.)

At 406, the process 400 may include retrieving at least a first record, in accordance with some embodiments. Referring to FIG. 1 for example, when the audit system begins an audit of the POS transaction records, the POS transaction records may be retrieved from the storage as noted at 404 for processing of the one or more checks, such as article ID check 1504A, unit of measure check 1504B, and/or other audit checks 1504C.

At 408, the process 400 may include checking the first record for a first error in the first record, in accordance with some embodiments. Referring to FIG. 1 for example, a first transaction record (which is retrieved at 406) may be undergo one or more audit checks, such as the article ID check 1504A, the unit of measure check 1504B, and/or other audit checks 1504C. The checks may be performed, as noted, in a variety of ways. For example, the first transaction record may be presented at a UI where a user can identify the error. Alternatively, or additionally, the ML model 1550 and/or the audit checks (e.g., the article ID check 1504A, the unit of measure check 1504B, and/or other audit checks 1504C) may detect the error or possible error and identify the error as a possible error as shown at FIG. 3A.

At 410, the process 400 may include identifying, for the first error in the first record, a first correction, in accordance with some embodiments. For example, when the first error is detected, such as a unit of measure error (e.g., cart 304A), the corresponding correction may be identified in a variety of ways. For example, the first error, such as the unit of measure error (e.g., cart 304A), may be presented at a user interface 300 where a user can confirm (or indicate) the first correction, such as “piece” 304B. Alternatively, or additionally, the ML model 1550 and/or the audit checks (e.g., the article ID check 1504A, the unit of measure check 1504B, and/or other audit checks 1504C) may identify the first correction, such as “piece” 304B.”

At 412, the process 400 may include applying the first correction to the first record, in accordance with some embodiments. Referring to FIG. 3A, the first correction may be applied automatically when confirmed using the approve error and correction 305. Alternatively, or additionally, the ML model 1550 and/or the audit checks (e.g., the article ID check 1504A, the unit of measure check 1504B, and/or other audit checks 1504C) may include mappings from errors to correction and automatically apply the correction.

At 414, the process 400 may include identifying in the plurality records one or more second records with the first error, in accordance with some embodiments. Referring to FIG. 1 and FIG. 3B for example, the error scan and correction 1508 may scan (e.g., the POS transaction store) the plurality of POS transaction records for other POS transaction records with errors similar to or the same as the first error identified at 410.

At 416, the process 400 may include applying the first correction to the identified one or more second records, in accordance with some embodiments. Referring to FIG. 1 and FIGS. 3B-3C for example, the error scan and correction 1508 may apply (e.g., the POS transaction store 1502 or un-audited store 1602) first correction to the records identified at FIG. 3B as shown at FIG. 3C.

At 418, the process 400 may include passing the first record and the one or more second records to an ERP system, in accordance with some embodiments. As the first POS transaction record (which had the first correction applied at 412) and the one or more second POS transaction records (which gad the first correction applied at 416), these records may be considered audited (e.g., corrected) and then passed by a correction system (e.g., audit system 1500) to the ERP system 1600 for use in ERP analytics and the like.

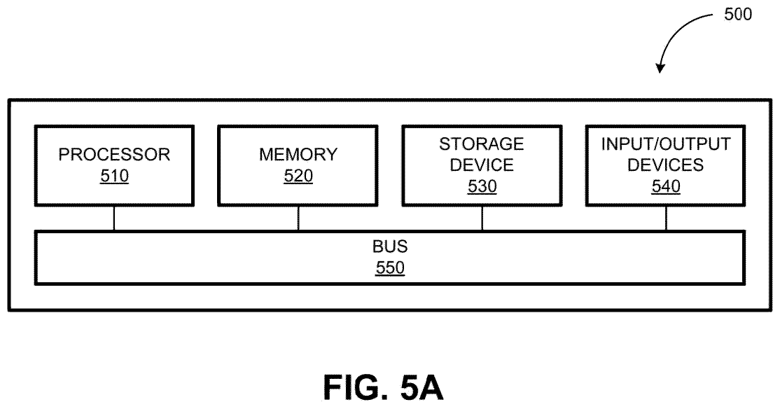

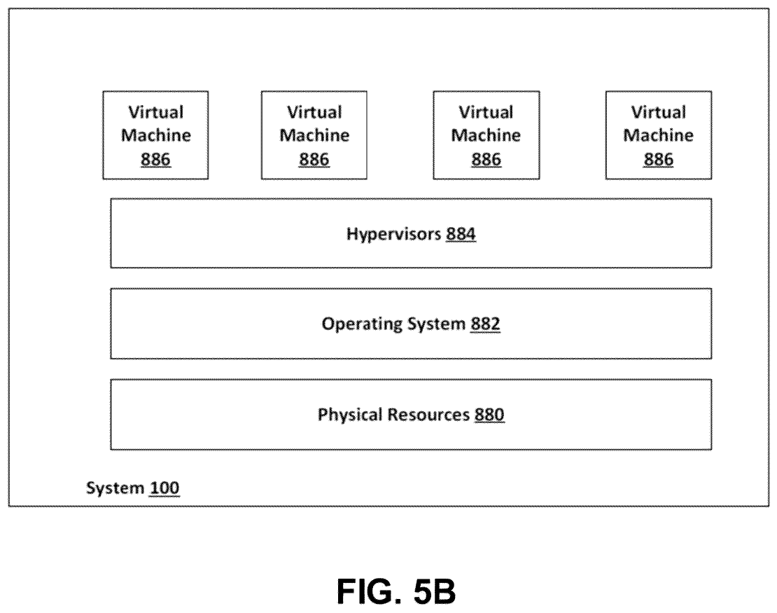

As shown in FIG. 5A, the computing system 500 can include a processor 510, a memory 520, a storage device 530, and input/output device 540. The processor 510, the memory 520, the storage device 530, and the input/output device 540 can be interconnected via a system bus 550. The processor 510 is capable of processing instructions (such as the instruction to implement the process 400 or other aspects disclosed herein) for execution within the computing system 500. Such executed instructions can implement one or more components of, for example, the database execution engine. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540. The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces. According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet). In some implementations of the current subject matter, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities, computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

FIG. 5B depicts an example implementation of the system 100 (of FIG. 1). The system 100 may be implemented using various physical resources 880, such as at least one or more hardware servers, at least one storage, at least one memory, at least one network interface, and the like. The system 100 may also be implemented using infrastructure, as noted above, which may include at least one operating system 882 for the physical resources 880 and at least one hypervisor 884 (which may create and run at least one virtual machine 886). For example, the audit system 1500, ERP system 1600, and/or other components at FIG. 1 may be run on a corresponding virtual machine 886.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1: A computer-implemented method comprising:
receiving one or more records from a point-of-service transaction device;
storing the received one or more records in a transaction store further including a plurality of records;
retrieving at least a first record;
checking the first record for a first error in the first record;
identifying, for the first error in the first record, a first correction;
applying the first correction to the first record;
identifying in the plurality records one or more second records with the first error;
applying the first correction to the identified one or more second records; and
passing the first record and the one or more second records as corrected records to an enterprise resource planning system.

Example 2: The computer-implemented method of Example 1, wherein the one or more records are received by a correction system coupled to the enterprise resource planning system.

Example 3: The computer-implemented method of any of Examples 1-2, wherein the transaction store is located at the correction system, and wherein the transaction store stores the plurality of records that have not been corrected by the correction system.

Example 4: The computer-implemented method of any of Examples 1-3, wherein the correction system retrieves the first record from the transaction store.

Example 5: The computer-implemented method of any of Examples 1-4, wherein the correction system performs one or more checks on the first record.

Example 6: The computer-implemented method of any of Examples 1-5, wherein the one or more checks comprise a unit of measure check and/or an article identifier check.

Example 7: The computer-implemented method of any of Examples 1-6, wherein the one or more checks further comprise generating a user interface including the first error to enable confirmation of the first error.

Example 8: The computer-implemented method of any of Examples 1-7, wherein the one or more checks further comprise detecting by a machine learning model the first error, wherein the machine learning model comprises a convolutional neural network trained using records with errors and records without errors.

Example 9: The computer-implemented method of any of Examples 1-8, wherein the first correction is identified using a confirmation received from a user interface and/or a machine learning model.

Example 10: A system comprising:
at least one processor; and

at least one memory including instructions which when executed by the at least one processor causes operations comprising:
receiving one or more records from a point-of-service transaction device;
storing the received one or more records in a transaction store further including a plurality of records;
retrieving at least a first record;
checking the first record for a first error in the first record;
identifying, for the first error in the first record, a first correction;
applying the first correction to the first record;
identifying in the plurality records one or more second records with the first error;
applying the first correction to the identified one or more second records; and
passing the first record and the one or more second records as corrected records to an enterprise resource planning system.

Example 11: The system of Example 10, wherein the one or more records are received by a correction system coupled to the enterprise resource planning system.

Example 12: The system of any of Examples 10-11, wherein the transaction store is located at the correction system, and wherein the transaction store stores the plurality of records that have not been corrected by the correction system.

Example 13: The system of any of Examples 10-12, wherein the correction system retrieves the first record from the transaction store.

Example 14: The system of any of Examples 10-13, wherein the correction system performs one or more checks on the first record.

Example 15: The system of any of Examples 10-14, wherein the one or more checks comprise a unit of measure check and/or an article identifier check.

Example 16: The system of any of Examples 10-15, wherein the one or more checks further comprise generating a user interface including the first error to enable confirmation of the first error.

Example 17: The system of any of Examples 10-16, wherein the one or more checks further comprise detecting by a machine learning model the first error, wherein the machine learning model comprises a convolutional neural network trained using records with errors and records without errors.

Example 18: The system of any of Examples 10-17, wherein the first correction is identified using a confirmation received from a user interface and/or a machine learning model.

Example 19: A non-transitory computer-readable storage medium including code which when executed by at least one processor causes operations comprising:
receiving one or more records from a point-of-service transaction device;
storing the received one or more records in a transaction store further including a plurality of records;
retrieving at least a first record;
checking the first record for a first error in the first record;
identifying for the first error in the first record a first correction;
applying the first correction to the first record;
identifying in the plurality records one or more second records with the first error;
applying the first correction to the identified one or more second records; and
passing the first record and the one or more second records as corrected records to an enterprise resource planning system.

Example 20: The non-transitory computer-readable storage medium of Example 19, wherein the one or more records are received by a correction system coupled to the enterprise resource planning system.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method comprising:
receiving one or more records from a point-of-service transaction device;
storing the received one or more records in a transaction store further including a plurality of records;
retrieving at least a first record;
checking the first record for a first error in the first record;
identifying, for the first error in the first record, a first correction;
applying the first correction to the first record;
identifying in the plurality records one or more second records with the first error;
applying the first correction to the identified one or more second records; and
passing the first record and the one or more second records as corrected records to an resource planning system.

2. The computer-implemented method of claim 1, wherein the one or more records are received by a correction system coupled to the enterprise resource planning system.

3. The computer-implemented method of claim 2, wherein the transaction store is located at the correction system, and wherein the transaction store stores the plurality of records that have not been corrected by the correction system.

4. The computer-implemented method of claim 2, wherein the correction system retrieves the first record from the transaction store.

5. The computer-implemented method of claim 2, wherein the correction system performs one or more checks on the first record.

6. The computer-implemented method of claim 5, wherein the one or more checks comprise a unit of measure check and/or an article identifier check.

7. The computer-implemented method of claim 5, wherein the one or more checks further comprise generating a user interface including the first error to enable confirmation of the first error.

8. The computer-implemented method of claim 5, wherein the one or more checks further comprise detecting by a machine learning model the first error, wherein the machine learning model comprises a convolutional neural network trained using records with errors and records without errors.

9. The computer-implemented method of claim 1, wherein the first correction is identified using a confirmation received from a user interface and/or a machine learning model.

10. A system comprising:
at least one processor; and
at least one memory including instructions which when executed by the at least one processor causes operations comprising:
receiving one or more records from a point-of-service transaction device;
storing the received one or more records in a transaction store further including a plurality of records;
retrieving at least a first record;
checking the first record for a first error in the first record;
identifying for the first error in the first record a first correction;
applying the first correction to the first record;
identifying in the plurality records one or more second records with the first error;
applying the first correction to the identified one or more second records; and
passing the first record and the one or more second records as corrected records to an enterprise resource planning system.

11. The system of claim 10, wherein the one or more records are received by a correction system coupled to the enterprise resource planning system.

12. The system of claim 11, wherein the transaction store is located at the correction system, and wherein the transaction store stores the plurality of records that have not been corrected by the correction system.

13. The system of claim 11, wherein the correction system retrieves the first record from the transaction store.

14. The system of claim 11, wherein the correction system performs one or more checks on the first record.

15. The system of claim 14, wherein the one or more checks comprise a unit of measure check and/or an article identifier check.

16. The system of claim 14, wherein the one or more checks further comprise generating a user interface including the first error to enable confirmation of the first error.

17. The system of claim 14, wherein the one or more checks further comprise detecting by a machine learning model the first error, wherein the machine learning model comprises a convolutional neural network trained using records with errors and records without errors.

18. The system of claim 10, wherein the first correction is identified using a confirmation received from a user interface and/or a machine learning model.

19. A non-transitory computer-readable storage medium including code which when executed by at least one processor causes operations comprising:
receiving one or more records from a point-of-service transaction device;
storing the received one or more records in a transaction store further including a plurality of records;
retrieving at least a first record;
checking the first record for a first error in the first record;
identifying for the first error in the first record a first correction;
applying the first correction to the first record;
identifying in the plurality records one or more second records with the first error;
applying the first correction to the identified one or more second records; and
passing the first record and the one or more second records as corrected records to an enterprise resource planning system.

20. The non-transitory computer-readable storage medium of claim 19, wherein the one or more records are received by a correction system coupled to the enterprise resource planning system.
